(19) United States
(12) Patent Application Publication
(10) Pub. No.: US 2022/0335332 A1
(43) Pub. Date: Oct. 20, 2022

(54) METHOD AND APPARATUS FOR SELF-TRAINING OF MACHINE READING COMPREHENSION TO IMPROVE DOMAIN ADAPTATION

(71) Applicant: KONKUK UNIVERSITY INDUSTRIAL COOPERATION CORP, Seoul (KR)

(72) Inventors: Harksoo Kim, Seoul (KR); Hyeon Gu Lee, Gyeonggi-do (KR)

(73) Assignee: KONKUK UNIVERSITY INDUSTRIAL COOPERATION CORP, Seoul (KR)

(21) Appl. No.: 17/502,746

(22) Filed: Oct. 15, 2021

(30) Foreign Application Priority Data
Apr. 14, 2021 (KR) 10-2021-0048285

(51) Int. Cl. G06N 20/00; G06F 40/289

(52) U.S. Cl. CPC G06N 20/00; G06F 40/289

(57) ABSTRACT

Disclosed are a method and apparatus for self-training of machine reading comprehension to improve domain adaptation. The method for self-training of the machine reading comprehension may include generating a pseudo training data set comprising pseudo-questions and pseudo-answers in response to a change in a domain to which a trained machine reading comprehension model is to be applied, refining the pseudo training data set, and retraining the machine reading comprehension model and a pseudo-question generator that generates the pseudo-questions using the refined pseudo training data set.

### CROSS-REFERENCE TO RELATED APPLICATION

This application claims the benefit of Korean Patent Application No. 10-2021-0048285 filed on Apr. 14, 2021, in the Korean Intellectual Property Office, the entire disclosure of which is incorporated herein by reference for all purposes.

### BACKGROUND

### 1. Field of the Invention

One or more example embodiments relate to a method and apparatus for self-training of machine reading comprehension to improve domain adaptation.

### 2. Description of the Related Art

A machine reading comprehension (for example, a machine reading comprehension model) refers to software (for example, a software module) that comprehends a given document through machine learning and finds a span (for example, a starting point and an ending point of a correct answer) corresponding to a correct answer within the document when a user query is inputted. Conventional machine reading comprehension shows a human-level or an exceeding human-level performance (for example, 90% level) with respect to a specific domain when approximately 80,000 to 100,000 items of training data are given.

When a training domain is different from an application domain, the performance decreases by approximately 20% to 30%. To overcome the decrease, an additional construction of data for the application domain is needed.

Constructing large-scaled training data additionally whenever the application domain is changed impedes a commercialization of the machine reading comprehension. The above description is information the inventor(s) acquired during the course of conceiving the present disclosure, or already possessed at the time, and is not necessarily art publicly known before the present application was filed.

### SUMMARY

Example embodiments may provide a self-training framework to improve a performance of a machine reading comprehension model by itself without a human intervention when a domain in which the machine reading comprehension model is trained is different from a domain to be applied.

Example embodiments may provide a self-training framework to improve a performance of an application domain by automatically generating human-like pseudo-questions and human-like pseudo-answers, (for example, pseudo-responses, pseudo-correct answers) from a collection of documents in the application domain and additionally learning ideally combined conventional training data with the human-like pseudo-questions and the human-like pseudo-answers.

However, the technical aspects are not limited to the aforementioned aspects, and other technical aspects may be present.

A method for self-training of a machine reading comprehension model may include generating a pseudo training data set including pseudo-questions and pseudo-answers in response to a change in a domain to which a trained machine reading comprehension model is to be applied, refining the pseudo training data set, and retraining the machine reading comprehension model and a pseudo-question generator that generates the pseudo-questions using the refined pseudo training data set.

The generating may include extracting the pseudo-answers through a pseudo-answer extractor from a document of a target domain to which the machine reading comprehension model is to be applied, and generating the pseudo-questions through the pseudo-question generator from the document of the target domain.

The refining may include refining the pseudo training data set based on predicted-answers of the machine reading comprehension model to the pseudo-questions.

The refining based on the predicted-answers may include calculating F1-scores between the pseudo-answers and the predicted-answers, and removing a pair of a pseudo-question and a pseudo-answer having a lower F1-score than a threshold value in the pseudo training data set.

The retraining may include retraining the machine reading comprehension model by concatenating a source training data set and the refined pseudo training data set, wherein the source training data set is used to pretrain the machine reading comprehension model in a source domain.

The retraining may further include retraining the pseudo-question generator based on reinforcement learning using the refined pseudo training data set.

The extracting may include learning a position distribution from starting words of the pseudo-answers to ending words of the pseudo-answers while scanning an input from a first word to a last word, and learning a position distribution from the ending words of the pseudo-answers to the starting words of the pseudo-answers while scanning the input from the last word to the first word.

An apparatus for performing self-training of a machine reading comprehension model may include a memory configured to store one or more instructions, a processor configured to execute the instructions, wherein when the instructions are executed, the processor is configured to generate a pseudo training data set comprising pseudo-questions and pseudo-answers in response to a change in a domain to which a trained machine reading comprehension model is to be applied, and refine the pseudo training data set, and retrain the machine reading comprehension model and a pseudo-question generator that generates the pseudo-questions using the refined pseudo training data set.

The processor may further be configured to extract the pseudo-answers through a pseudo-answer extractor from a document of a target domain to which the machine reading comprehension model is to be applied, and generate the pseudo-questions through the pseudo-question generator from the document of the target domain.

The processor may further be configured to refine the pseudo training data set based on predicted-answers of the machine reading comprehension model to the pseudo-questions.

The processor may further be configured to calculate F1-scores between the pseudo-answers and the predicted-answers, and remove a pair of a pseudo-question and a pseudo-answer having a lower F1-score than a threshold value in the pseudo training data set.

The processor may further be configured to retrain the machine reading comprehension model by concatenating a source training data set and the refined pseudo training data set, wherein the source training data set is used to pretrain the machine reading comprehension model in a source domain.

The processor may further be configured to retrain the pseudo-question generator based on reinforcement learning using the refined pseudo training data set.

The processor may further be configured to learn a position distribution from starting words of the pseudo-answers to ending words of the pseudo-answers while scanning an input from a first word to a last word, and learn a position distribution from the ending words of the pseudo-answers to the starting words of the pseudo-answers while scanning the input from the last word to the first word.

The processor may further be configured to learn a position distribution from starting words of the pseudo-answers to ending words of the pseudo-answers while scanning an input from a first word to a last word, and learn a position distribution from the ending words of the pseudo-answers to the starting words of the pseudo-answers while scanning the input from the last word to the first word.

Additional aspects of example embodiments will be set forth in part in the description which follows and, in part, will be apparent from the description, or may be learned by practice of the disclosure.

### BRIEF DESCRIPTION OF THE DRAWINGS

FIG. 1 illustrates a domain adaptation issue.

FIG. 2 is a diagram illustrating a machine reading comprehension framework according to example embodiments.

FIG. 3 is a flowchart illustrating self-training performed by a machine reading comprehension apparatus according to example embodiments.

FIG. 4 is a diagram illustrating an example of a pseudo-answer extractor.

FIG. 5 is a diagram illustrating an example of a pseudo-question generator.

FIG. 6 is a diagram illustrating an example of a machine reading comprehension model.

FIG. 7 is a block diagram illustrating a machine reading comprehension apparatus according to example embodiments.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like components and a repeated description related thereto will be omitted.

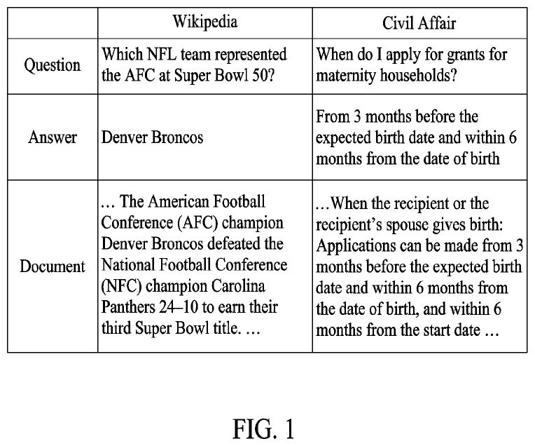

FIG. 1 is a diagram illustrating a domain adaptation issue.

A machine reading comprehension (MRC) is a method for learning how to read a document on a computer and answer to a related question. A MRC model may answer to an unknown type of a question since the MRC model learns an abstract level of function to comprehend a document. MRC has rapidly developed through an attention mechanism. Bidirectional attention flow achieved a high performance when used to calculate a relationship between a query and a context. R-Net was the first to use self-attention to analyze a relationship between words in a predetermined context. The two models (for example, bidirectional attention flow and R-Net) were used as bases for many MRC studies in an early stage. However, recent MRC models have a basis on fine-tuning of pretrained large-scaled language models, for example, BERT, ALBERT, and ELECTRA.

An accuracy of the MRC model exceeds an accuracy of a human. When an input document differs from training data in various linguistic aspects (for example, a writing style and vocabulary), for example, when an application domain is changed, the MRC model may show a considerable performance degradation. That is, a domain adaptation issue.

FIG. 1 illustrates a linguistic difference between a document from Wikipedia and a civil affair document. As shown in FIG. 1, a MRC model trained in Wikipedia may not easily obtain an answer (for example, a correct answer) in the civil affair document, which may be because a clue word is unknown (for example, out of vocabulary) or an expected answer type (for example, a list of reasons) is not familiar with a domain of Wikipedia.

A method for overcoming the domain adaptation issue may be fine-tuning the MRC model using newly constructed training data in a target domain (for example, a domain to which the MRC is to be applied). It may be time consuming and labor intensive to newly construct massive training data. Studies related to domain adaptation may be classified into a method based on model generalization and a method based on adversarial training.

D-Net was used to solve the domain adaptation issue by generalizing the MRC model through multitask learning MRC training data in various domains. A training purpose of D-Net was to extract a common feature from a multidomain document. D-Net may calculate a result with a low domain dependency. However, a cost of constructing multidomain training data may be enormous.

Adversarial domain adaptation framework, known as AdaMRC, was proposed to reduce the construction cost. In AdaMRC, a question generator may generate a question-answer pair. A domain classifier for predicting a domain of the pair of the question and the answer may be integrated into the MRC model. During training, the MRC model and the domain classifier may be jointly trained through the adversarial training to execute domain-independent expression learning. AdaMRC may show a decent ability in domain adaptation, however, the question generator may be excluded in a training process. Thus, when the question generator returns a low-quality question, it is difficult to obtain a better performance from the MRC model in the target domain.

An unsupervised domain adaptation method through conditional adversarial learning was also proposed. However, this model may have a critical restriction, that is, a target domain shall have a similar linguistic characteristic to a source domain.

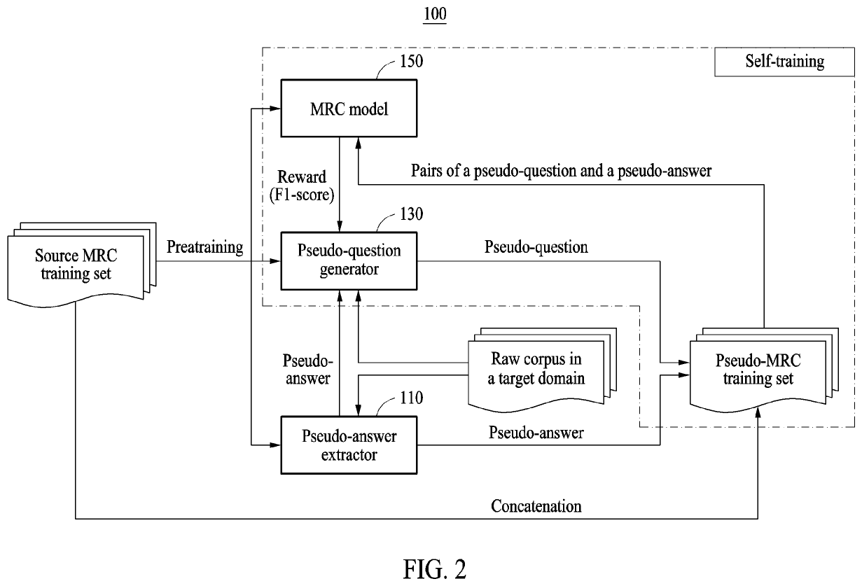

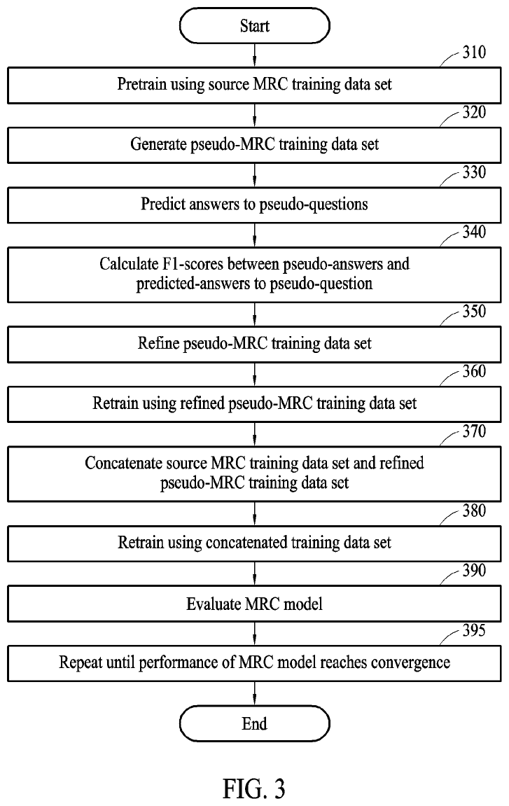

FIG. 2 is a diagram illustrating a MRC framework according to example embodiments and FIG. 3 is a flowchart illustrating self-training performed by a MRC apparatus according to example embodiments.

A MRC apparatus 100 may include a MRC framework (for example, a self-training framework) to mitigate the domain adaptation issue without a human intervention. The MRC framework within the MRC apparatus 100 may include a pseudo-answer extractor 110, a pseudo-question generator 130, and a MRC model 150.

The pseudo-answer extractor 110 may determine (for example, extract) all possible phrases for answers (for example, pseudo-answers (correct answers)) from each document, and may output all the determined possible phrases as pseudo-answers. The pseudo-question generator 130 may generate questions (for example, reasonable pseudo-questions) related to the pseudo-answers based on contexts of the pseudo-answers (for example, surrounding words of the pseudo-answers and words enclosing the pseudo-answers). The MRC model 150 may return phrases (for example, predicted-answers) to answer the questions (for example, including the pseudo-questions).

The MRC apparatus 100 may perform a self-training operation using the MRC framework. The self-training operation may include a pretraining operation (for example, operation 310) and a domain adaptation operation (for example, operations 320 through 395). The pre-training operation may be performed in a source domain, and the domain adaptation operation may be performed in a target domain (for example, an application domain).

In operation 310, the MRC apparatus 100 may perform pretraining using a source MRC training data set (for example, a collection of documents and question-answer pairs in the source domain). For example, the MRC apparatus 100 may pretrain the pseudo-answer extractor 110, the pseudo-question generator 130, and the MRC model 150 by using the source MRC training data set.

In the operation 320, the MRC apparatus 100 may generate a pseudo-MRC training data set (for example, a set of documents, pseudo-questions, and pseudo-answers in the target domain) through the pseudo-answer extractor 110 and the pseudo-question generator 130. The pseudo-MRC training data set may be pseudo data and may refer to an initial pseudo-MRC training data set. The pseudo-answer extractor 110 may extract pseudo-answers from documents in the target domain (for example, a collection of documents and a raw corpus). The pseudo-question generator 130 may generate pseudo-questions from the documents in the target domain. The pseudo-answers and the pseudo-questions obtained from the documents in the target domain may be interrelated.

In the operation 330, the MRC model 150 may predict (for example, extract) answers (for example, predicted-answers) to the pseudo-questions from the documents (for example, documents in the target domain).

In the operation 340, the MRC model 150 may calculate F1 scores (for example, an overlap ratio of words) between the pseudo-answers and the predicted-answers to the pseudo-questions.

In the operation 350, the MRC apparatus 100 may refine the pseudo-MRC training data set. For example, the MRC apparatus 100 may remove a pair of a pseudo-question and a pseudo-answer having a lower F1-score than a predefined threshold value in the pseudo-MRC training data set. A pair of a pseudo-question and a pseudo-answer having a high F1-score in the pseudo-MRC training data set may be selected as reliable MRC training data for a data augmentation of the target domain.

In the operation 360, the MRC apparatus 100 may retrain the pseudo-question generator 130 using the refined pseudo-MRC training data set (for example, the reliable pseudo-MRC training data set). The retraining may be performed based on reinforcement learning using the F1-score as a reward.

In the operation 370, the MRC apparatus 100 may concatenate the source MRC training data set and the refined pseudo-MRC training data set.

In the operation 380, the MRC apparatus 100 may retrain the MRC model 150 using the concatenated training data set. That is, the MRC apparatus 100 may generate the MRC model 150 suitable for the target domain.

In the operation 390, the MRC apparatus 100 may evaluate the MRC model 150 using a development data set of the target domain.

In the operation 395, the MRC apparatus 100 may repeat operations 320 through 390 until a performance of the MRC model 150 reaches convergence.

In the target domain during the domain adaption operation, a mutual self-training may be performed, wherein the pseudo-question generator 130 may provide new training data to the MRC model 150 and receive a reward from the MRC model 150 for reinforcement learning. Performances of the pseudo-question generator 130 and the MRC model 150 may be improved through a mutual self-training scheme in the target domain.

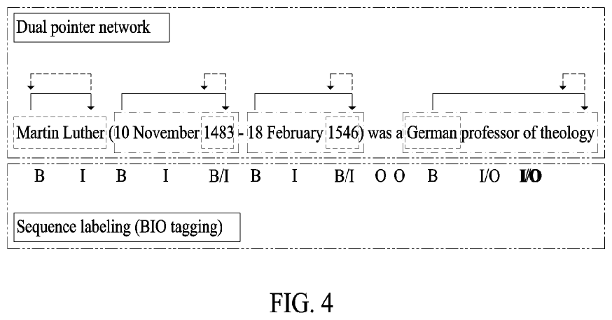

FIG. 4 is a diagram illustrating an example of a pseudo-answer extractor.

While the MRC model 150 is trained, the pseudo-answer extractor 110 may extract (for example, automatically obtain) a phrase which may be used as a golden answer (for example, an answer made by a human) from a document (for example, a raw corpus and a collection of documents in the target domain). The pseudo-answer extractor 110 may be a pseudo-answer extractor based on a sequence labeling model or a dual pointer network model. In FIG. 4, a difference between the sequence labeling model and the dual pointer network model may be confirmed in a pseudo-answer extraction task.

The sequence labeling model may regard a pseudo-answer extraction as a sequence labeling task based on a beginner-inner-outer (BIO) tagging scheme. The sequence labeling model may not extract an overlapped pseudo-answer. For example, when a question “When was Martin Luther born?” is asked, both the noun phrase “10 Nov. 1483” and the short noun phrase “1483” may be pseudo-answers with high possibilities. However, the sequence labeling model may extract the entire noun phrase “10 Nov. 1483” or the non-overlapped phrases “10 November” and “1483”.

The pseudo-answer extractor 110 based on the dual pointer network model may overcome the issue described above. The dual pointer network may include an encoder and two decoders (for example, a forward decoder and a backward decoder). The forward decoder may learn a position distribution from starting words of pseudo-answers to ending words of the pseudo-answers while scanning an input sentence from a first word to a last word. Conversely, the backward decoder may learn a position distribution from the ending words of the pseudo-answers to the starting words of the pseudo-answers while scanning the input sentence from the last word to the first word. The dual pointer network may be expressed as Equation 1.

$$\begin{matrix}{u}_{j}^{i , f} = {v}_{f}^{T} tanh ( {W}_{1}^{f} {e}_{j} + {W}_{2}^{f} {d}_{i}^{f} ) \\ {a}_{j}^{i , f} = softmax ( {u}_{j}^{i , f} ) \\ {d}_{i + 1}^{f} = GRU ( {d}_{i}^{f} , {\sum }_{j = 1}^{n} {a}_{j}^{i , f} {e}_{j} ) \\ {u}_{j}^{i , b} = {v}_{b}^{T} tanh ( {W}_{1}^{b} {e}_{j} + {W}_{2}^{b} {d}_{i}^{b} ) \\ {a}_{j}^{i , b} = softmax ( {u}_{j}^{i , b} ) \\ {d}_{i + 1}^{b} = GRU ( {d}_{i}^{b} , {\sum }_{j = 1}^{n} {a}_{j}^{i , b} {e}_{j} ) ,\end{matrix} \qquad [ Equation 1 ]$$

Here, f may denote a forward direction and b may denote a backward direction. eⱼ may be a j-th hidden vector of the encoder, and dᵢ may be an i-th hidden vector of each decoder. uⱼⁱ may be an attention score between eⱼ and dᵢ. aⱼⁱ may be a softmax normalized score of uⱼⁱ. GRU may refer to a gated recurrent unit. W₁^{f}, W₂^{f}, v_{f}^{T}, W₁^{b}, W₂^{b}, and v_{b}^{R} may be weight matrices which are learnable parameters.

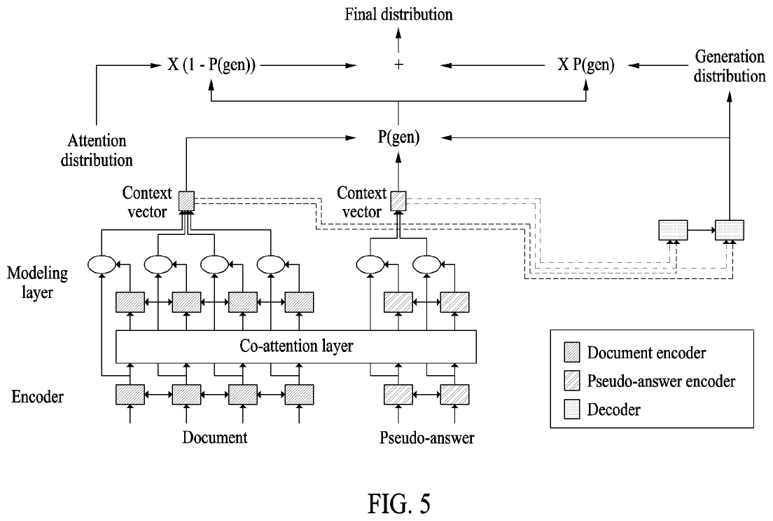

FIG. 5 is a diagram illustrating an example of a pseudo-question generator.

The pseudo-question generator 130 may automatically generate pseudo-questions related to a document (for example, a raw corpus and a collection of documents in a target domain) and pseudo-answers extracted from the document (for example, pseudo-questions suitable for the document and the pseudo-answers extracted from the document). The pseudo-question generator 130 may have a basis on a pointer generator and generate reliable pseudo-questions. The pseudo-question generator 130 may generate pseudo-questions focusing on pseudo-answers based on the pointer generator as shown in FIG. 5.

The pointer generator may receive a document and the pseudo-answer extracted from the document as two input types. This may be to generate the pseudo-questions based on the pseudo-answers in the same document. To indicate an association (for example, a relation) between words in the document and words in the pseudo-answers, the pointer generator may calculate a bi-directional attention in a co-attention layer as Equation 2.

$$\begin{matrix}{C}_{i} = BiGRU ( {word}_{i} , {p os}_{i} ) \\ {A}_{j} = BiGRU ( {word}_{j} , {pos}_{j} ) \\ {V}_{ij} = {W}^{att} [ {C}_{i} ; {A}_{j} ; {C}_{i} ∘ {A}_{j} ] \\ {att}_{i}^{CA} = softmax ( {V}_{i} ) \\ \tilde{{A}_{i}} = {\sum }_{k = 0}^{n} {att}_{i}^{CA} {A}_{k} \\ {att}^{AC} = softmax ( max ( {V}_{i} ) ) \\ \tilde{c} = {\sum }_{i = 0}^{m} {att}_{i}^{AC} {C}_{i} \\ {e}_{i} = [ {C}_{i} ; \tilde{{A}_{i}} ; {C}_{i} ∘ \tilde{{A}_{i}} ; {C}_{i} ∘ {C}_{i} ] ,\end{matrix} \qquad [ Equation 2 ]$$

Here, Cᵢ may be an i-th word embedding (for example, a word embedding vector) in a document (for example, a context) and a pseudo-answer re-encoded by bi-directional recurrent neural networks (biRNNs) to which a word embedding wordᵢ (for example, a word embedding vector) and a position embedding posᵢ (for example, a position embedding vector) are provided as inputs. Aⱼ may be a j-th word embedding (for example, a word embedding vector) in a document (for example, a context) and a pseudo-answer re-encoded by biRNNs to which a word embedding wordⱼ (for example, a word embedding vector) and a position embedding posⱼ (for example, a position embedding vector) are provided as inputs. In addition, CᵢºAⱼ may be an element-wise multiplication between Cᵢ and Aⱼ. W^{att} may be a weight matrix, and Vᵢⱼ may be a relevance score between the i-th word in the document and the j-th word of the pseudo-answer. Next, Vᵢ may be a relevance vector between the i-th word in the document and all words in the pseudo-question. Lastly, Ãᵢ may be a context-to-answer attention vector (for example, a co-attention vector from the document to the pseudo-answer). An answer-to-context attention vector \tilde{C}ᵢ (for example, a co-attention vector from the pseudo-answer to the document) may be obtained by tiling \tilde{c} as many times as the number of words in the document. eᵢ may be a final encoding vector of the i-th word in the document obtained from combining an answer-to-context attention vector and a context-to-answer attention vector.

In a decoding operation, a generation probability distribution may be priorly obtained through a GRU decoder (for example, a GRU decoder) based on an encoder-decoder attention mechanism as given in Equation 3.

$$\begin{matrix}{s}_{i}^{t} = {v}^{T} tanh ( {W}_{e} {e}_{i} + {W}_{d} {d}_{t} + {b}_{att} ) \\ {a}^{t} = softmax ( {s}^{t} ) \\ {h}_{t} = {\sum }_{i = 1}^{n} {a}_{i}^{t} {e}_{i} \\ {P}_{vocab} = softmax ( {W}_{1}^{gen} ( {W}_{2}^{gen} [ {d}_{t} , {h}_{t} ] + {b}_{1} ) + b 2 ) ,\end{matrix} \qquad [ Equation 3 ]$$

Here, eᵢ may be an encoding vector of an i-th word in the document and dₜ may be a hidden vector of a t-th decoding operation. hₜ may be an encoder-decoder attention vector, known as a context vector, in the t-th decoding operation. In addition, v, Wₑ, W_{d}, W₁^{gen}, W₂^{gen}, bₐₜₜ, b₁, and b₂ may be learnable parameters. Next, a copy probability may be calculated by Equation 4.

p_{gen}=σ(Wₕ^{T}hₜ+W_{d}^{T}dₜ+Wₓ^{T}xₜ+bₚₜᵣ), [Equation 4]

Here, Wₕ^{T}, W_{d}^{T}, Wₓ^{T}, and bₚₜᵣ may be learnable parameters, and σ may be a sigmoid function. The copy probability p_{gen} may be used as a soft switch to select between generating a new word and copying a word from the document as given by Equation 5.

$$P ( w ) = {P}_{gen} {P}_{vocab} ( w ) + ( 1 - {P}_{gen} ) {\sum }_{i = 1}^{n} {a}_{i}^{t} \qquad [ Equation 5 ]$$

The pseudo-question generator 130 may perform self-training based on a loss function. The loss function for self-training may be represented by adding a reinforcement learning loss L_{RL} to a negative log likelihood loss L_{NLL}, as expressed by Equation 6.

$$\begin{matrix}{L}_{NLL} ( θ ) = \frac{1}{T} {\sum }_{t = 1}^{T} - log P ( {w}_{t} ) \\ {L}_{RL} ( θ ) = - {E}_{\hat{W} \sim {p}_{θ} ( W \vert C , A )} [ F 1 ( MRC ( C , \hat{W} ) , A ) ] \\ L ( θ ) = {λ L}_{NLL} θ + ( 1 - λ ) {L}_{RL} ( θ ) ,\end{matrix} \qquad [ Equation 6 ]$$

Here, Wₜ may denote a t-th word of a generated pseudo-question, C may denote a document, and Ŵ may denote the generated pseudo-question. A may denote a pseudo-answer related to the generated pseudo-question Ŵ. In addition, MRC may represent the MRC model 150, F1 may denote an F1-score function, Emay denote an expected value (for example, a predicted-answer), λ and may represent a smoothing factor empirically set from 0 to 1. The F1-score may be calculated by comparing an answer predicted by the MRC model 150 and a pseudo-answer provided in accordance with a lexical overlap between the words. For example, the F1-score between the predicted answer “10 November” and the pseudo-answer “10 Nov. 1483” is 0.8 because a precision is 2/2 and a recall rate is 2/3.

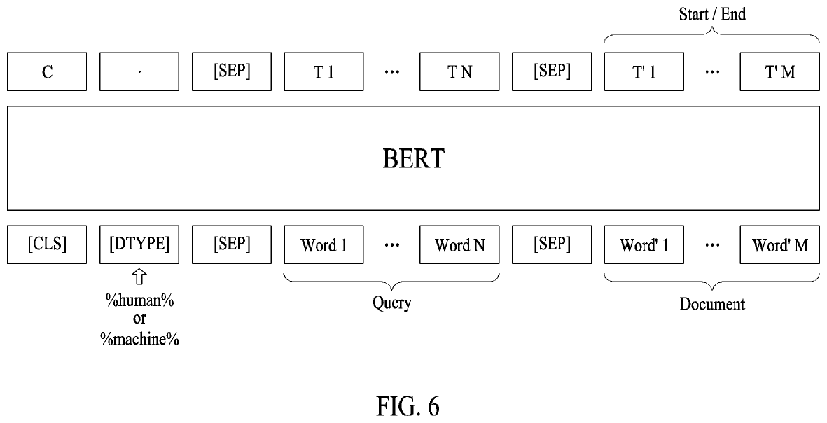

FIG. 6 is a diagram illustrating an example of a MRC model.

Self-training of the MRC model 150 may be achieved through mutual feedback with the pseudo-question generator 130. The pseudo-question generator 130 may deliver (for example, output) pseudo-questions to the MRC model 150. The MRC model 150 may evaluate the pseudo-questions, calculate a reward for reinforcement learning of the pseudo-question generator 130, and deliver (for example, output) the reward to the pseudo-question generator 130.

During the mutual feedback process, a pseudo-MRC training data set (for example, a final pseudo-MRC training data set) including documents in a target domain and reliable pairs of pseudo-questions and pseudo-answers (for example, pairs with high F1-scores) may be constructed.

The MRC model 150 may include a special token to discriminate source MRC training data from pseudo-MRC training data. For example, the MRC model 150 may be a BERT-based MRC model to which the special token is added.

In general, the source MRC training data set used to pretrain the MRC model 150 may include a small amount of invalid data. This may be because the source MRC training data are manually constructed. Since the pseudo-MRC training data set used for domain adaptation is automatically constructed, the pseudo-MRC training data set may include more invalid data. Thus, a simple data augmentation (for example, a simple mixing of the source MRC training data set and a target training data set) may render the MRC model 150 to be overfitted by noise data.

In FIG. 6, [DTYPE] may be the special token to discriminate training data. In a training operation, when the source MRC training data are inputted to the MRC model 150, the special token may be set to “% human %.” When the pseudo-MRC training data are inputted to the MRC model 150, the special token may be set to “% machine %”. In a predicting operation, the special token may be set to “% human %”.

During the mutual self-training, the MRC model 150 may provide the reward to the pseudo-question generator 130 for reinforcement learning, and the pseudo-question generator 130 may provide the reliable data to the MRC model 150 for the data augmentation.

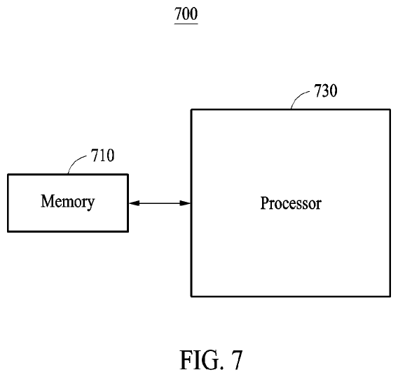

FIG. 7 is a block diagram illustrating a MRC apparatus according to example embodiments.

A MRC apparatus 700 (for example, the MRC apparatus 100 in FIG. 1) may perform self-training using a MRC framework (for example, a self-training framework) to mitigate the domain adaptation issue described with reference to FIGS. 1 to 6. The MRC apparatus 700 may include a memory 710 and a processor 730. The MRC framework in FIG. 2 (for example, the pseudo-answer extractor 110, the pseudo-question generator 130, and the MRC model 150 in FIG. 2) may be stored in the memory 710, loaded by the processor 730, and executed by the processor 730. In addition, the MRC framework may be embedded in the processor 730.

The memory 710 may store instructions (or programs) executable by the processor 730. For example, the instructions may include instructions to perform an operation of the processor 730 and/or an operation of each element of the processor 730.

The processor 730 may process data stored in the memory 710. The processor 730 may execute computer-readable codes (for example, software) stored in the memory 710 and instructions triggered by the processor 730.

The processor 730 may be a data processing device implemented by hardware including a circuit having a physical structure to perform desired operations. For example, the desired operations may include codes or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The operation performed by the processor 730 is substantially the same as the self-training operation using the pseudo-answer extractor 110, the pseudo-question generator 130, and the MRC model 150 described with reference to FIGS. 1 to 6. Accordingly, a detailed description will be omitted.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for self-training of a machine reading comprehension model, the method comprising:
generating a pseudo training data set comprising pseudo-questions and pseudo-answers in response to a change in a domain to which a trained machine reading comprehension model is to be applied;
refining the pseudo training data set; and
retraining the machine reading comprehension model and a pseudo-question generator that generates the pseudo-questions using the refined pseudo training data set.

2. The method of claim 1, wherein the generating comprises:
extracting the pseudo-answers through a pseudo-answer extractor from a document of a target domain to which the machine reading comprehension model is to be applied; and
generating the pseudo-questions through the pseudo-question generator from the document of the target domain.

3. The method of claim 1, wherein the refining comprises refining the pseudo training data set based on predicted-answers of the machine reading comprehension model to the pseudo-questions.

4. The method of claim 3, wherein the refining based on the predicted-answers comprises:
calculating F1-scores between the pseudo-answers and the predicted-answers; and
removing a pair of a pseudo-question and a pseudo-answer having a lower F1-score than a threshold value in the pseudo training data set.

5. The method of claim 1, wherein the retraining comprises retraining the machine reading comprehension model by concatenating a source training data set and the refined pseudo training data set, wherein the source training data set is used to pretrain the machine reading comprehension model in a source domain.

6. The method of claim 5, wherein the retraining further comprises retraining the pseudo-question generator based on reinforcement learning using the refined pseudo training data set.

7. The method of claim 2, wherein the extracting comprises:
learning a position distribution from starting words of the pseudo-answers to ending words of the pseudo-answers while scanning an input from a first word to a last word; and
learning a position distribution from the ending words of the pseudo-answers to the starting words of the pseudo-answers while scanning the input from the last word to the first word.

8. An apparatus for performing self-training of a machine reading comprehension model, comprising:
a memory configured to store one or more instructions; and
a processor configured to execute the instructions;
wherein when the instructions are executed, the processor is configured to:
generate a pseudo training data set comprising pseudo-questions and pseudo-answers in response to a change in a domain to which a trained machine reading comprehension model is to be applied, and
refine the pseudo training data set, and
retrain the machine reading comprehension model and a pseudo-question generator that generates the pseudo-questions using the refined pseudo training data set.

9. The apparatus of claim 8, wherein the processor is further configured to:
extract the pseudo-answers through a pseudo-answer extractor from a document of a target domain to which the machine reading comprehension model is to be applied, and
generate the pseudo-questions through the pseudo-question generator from the document of the target domain.

10. The apparatus of claim 8, wherein the processor is further configured to refine the pseudo training data set based on predicted-answers of the machine reading comprehension model to the pseudo-questions.

11. The apparatus of claim 10, wherein the processor is further configured to:
calculate F1-scores between the pseudo-answers and the predicted-answers, and
remove a pair of a pseudo-question and a pseudo-answer having a lower F1-score than a threshold value in the pseudo training data set.

12. The apparatus of claim 8, wherein the processor is further configured to retrain the machine reading comprehension model by concatenating a source training data set and the refined pseudo training data set, wherein the source training data set is used to pretrain the machine reading comprehension model in a source domain.

13. The apparatus of claim 12, wherein the processor is further configured to retrain the pseudo-question generator based on reinforcement learning using the refined pseudo training data set.

14. The apparatus of claim 9, wherein the processor is further configured to:
learn a position distribution from starting words of the pseudo-answers to ending words of the pseudo-answers while scanning an input from a first word to a last word, and
learn a position distribution from the ending words of the pseudo-answers to the starting words of the pseudo-answers while scanning the input from the last word to the first word.

15. A non-transitory computer-readable storage medium storing instructions that, when executed by a processor, cause the processor to perform the method of claim 1.
